(19) United States
(12) Patent Application Publication
(10) Pub. No.: US 2026/0054790 A1
(43) Pub. Date: Feb. 26, 2026

(54) RECREATIONAL VEHICLE FRONT CAP, REAR CAP, AND AERODYNAMICS

(71) Applicant: Winnebago Industries, Inc., Eden Prairie, MN (US)

(72) Inventors: Scott William Shaffar, Winchester, CA (US); Omkar Dass Thurumalla, Burlington (CA); Brian Daniel Durbin, Eden Prairie, MN (US)

(21) Appl. No.: 19/306,656

(22) Filed: Aug. 21, 2025

Related U.S. Application Data
(60) Provisional application No. 63/685,852, filed on Aug. 22, 2024.

(51) Int. Cl. B62D 63/08; B29C 51/12; B29K 55/02; B29L 31/30; B62D 25/06; B62D 29/04

(52) U.S. Cl. CPC B62D 63/08; B62D 25/06; B62D 29/043; B29C 51/12; B29K 2055/02; B29L 2031/30

(57) ABSTRACT

A front cap includes a front cap structure with an exterior surface and an interior surface. A first stiffener member includes a thermoformable material and is coupled to the interior surface. A second stiffener member includes a thermoformable material and is coupled to the interior surface. The front cap is designed for installation to a recreational vehicle trailer.

### REFERENCE TO RELATED APPLICATION

This application claims the benefit of U.S. Provisional Application No. 63/685,852, filed Aug. 22, 2024 and entitled Recreational Vehicle Front Cap, Rear Cap, and Aerodynamics, which is incorporated herein in its entirety and for all purposes.

### FIELD

This application relates generally to recreational vehicles. Embodiments include a towable recreational vehicle.

### SUMMARY

Certain embodiments of the present disclosure feature front cap and/or rear cap designs that provide—among other things—aerodynamic benefits, as described further herein. While multiple embodiments are disclosed, still other embodiments of the present invention will become apparent to those skilled in the art from the following detailed description, which shows and describes illustrative embodiments of the invention. Accordingly, the drawings and detailed description are to be regarded as illustrative in nature and not restrictive.

### BRIEF DESCRIPTION OF THE DRAWINGS

FIG. 1 shows a recreational vehicle, in accordance with certain embodiments of the present disclosure.

FIG. 2 shows a simplified schematic top view of an example floorplan of the recreational vehicle of FIG. 1, in accordance with certain embodiments of the present disclosure.

FIG. 3 shows an exploded view of a portion of the recreational vehicle of FIG. 1, in accordance with certain embodiments of the present disclosure.

FIG. 4 shows an interior portion of a front cap for the recreational vehicle of FIG. 1, in accordance with certain embodiments of the present disclosure.

FIG. 5 shows a top perspective view of a stiffener member, in accordance with certain embodiments of the present disclosure.

FIG. 6 shows a cutaway view of a portion of the recreational vehicle of FIG. 1, in accordance with certain embodiments of the present disclosure.

FIG. 7 shows a portion of the recreational vehicle of FIG. 1, in accordance with certain embodiments of the present disclosure.

FIG. 8 shows a bed and cabinet assembly of the recreational vehicle of FIG. 1, in accordance with certain embodiments of the present disclosure.

FIG. 9 shows a bed and cabinet assembly of the recreational vehicle of FIG. 1, in accordance with certain embodiments of the present disclosure.

FIG. 10 shows a front view of a front cap of the recreational vehicle of FIG. 1, in accordance with certain embodiments of the present disclosure.

FIG. 11 shows a cutaway view of a portion of the recreational vehicle of FIG. 1, in accordance with certain embodiments of the present disclosure.

FIG. 12 shows a rear wall and fairings for the recreational vehicle of FIG. 1, in accordance with certain embodiments of the present disclosure.

FIG. 13 shows a top view of the fairings of FIG. 11 and the roof, in accordance with certain embodiments of the present disclosure.

FIG. 14 shows a flowchart of a method for manufacturing aspects of a recreational vehicle, in accordance with certain embodiments of the present disclosure.

FIG. 15 shows a fifth wheel recreational vehicle, in accordance with certain embodiments of the present disclosure.

While the disclosure is amenable to various modifications and alternative forms, specific embodiments have been shown by way of example in the drawings and are described in detail below. The intention, however, is not to limit the disclosure to the particular embodiments described but instead is intended to cover all modifications, equivalents, and alternatives falling within the scope the appended claims.

### DETAILED DESCRIPTION

Certain embodiments of the present disclosure are directed to a front cap and/or a rear cap of a recreational vehicle such as a towable trailer. In certain embodiments, features of the front cap described herein provide an internal structure that can help save weight compared to traditional front cap designs. Further, the internal structure can provide additional internal living space volume compared to recreational vehicles that use traditional front cap designs. In certain embodiments, the front cap can incorporate an external surface that is shaped to provide aerodynamic benefits (e.g., reduced drag) compared to traditional front cap designs. In some embodiments, the rear cap (e.g., rear wall portion) of the recreational vehicle includes features that provide aerodynamic benefits compared to traditional rear cap designs. Tests of prototype towable embodiments have, for example, demonstrated improvements in fuel economy.

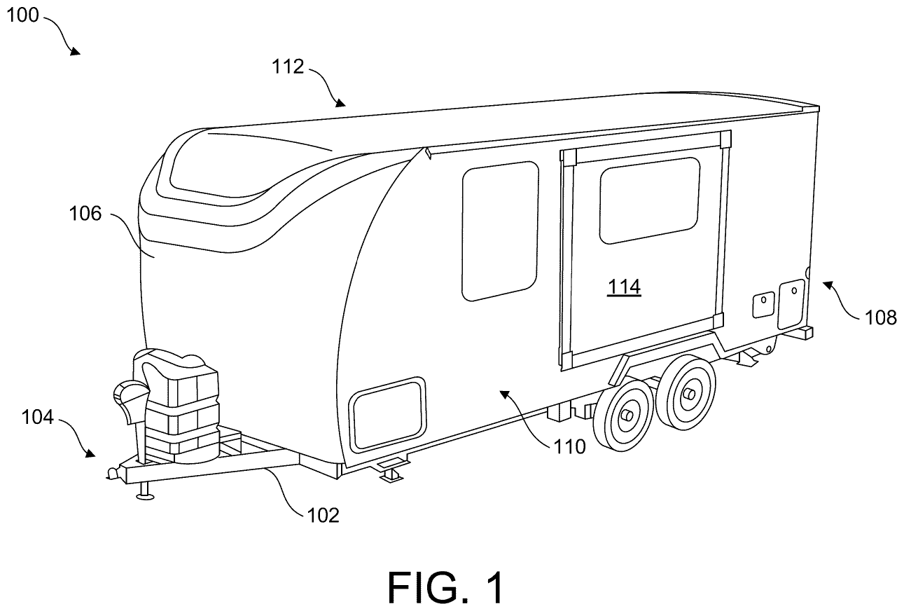

FIG. 1 shows a towable recreational vehicle such as a travel trailer 100 (hereinafter “the trailer 100” for brevity), which is designed to be mechanically coupled to a towing vehicle (e.g., car, truck, sport utility vehicle). The trailer 100 includes a body that houses a living area, and the body is supported by a chassis 102 that includes one or more axles. The trailer 100 includes a hitch area 104 positioned at a front end of the trailer 100 for removably attaching a coupler (e.g., a cuplike structure having a cavity) to a corresponding coupling member (e.g., a ball) of the towing vehicle such that the towing vehicle can tow or pull the trailer 100.

The trailer 100 extends between a front end 106 adjacent the hitch area 104 to a rear end 108. Between the front end 106 and the rear end 108 are sidewalls 110 and a roof 112. The sidewalls 110 can include one or more slideout assemblies 114.

In certain embodiments, the trailer 100 does not include an awning. Awnings contribute to aerodynamic drag as the trailer 100 is being towed. By not including an awning, aerodynamic drag can be reduced compared to trailers with an awning. In other embodiments, the trailer 100 includes an armless awning, which contributes less to aerodynamic drag compared to certain armed-awning designs.

As shown in FIG. 1, in certain embodiments, the roof 112 is a “clean” roof design where features such as HVAC systems, antennas, etc., are located elsewhere on the trailer 100. This further can reduce aerodynamic drag of the trailer 100 compared to trailers with components protruding from its roof.

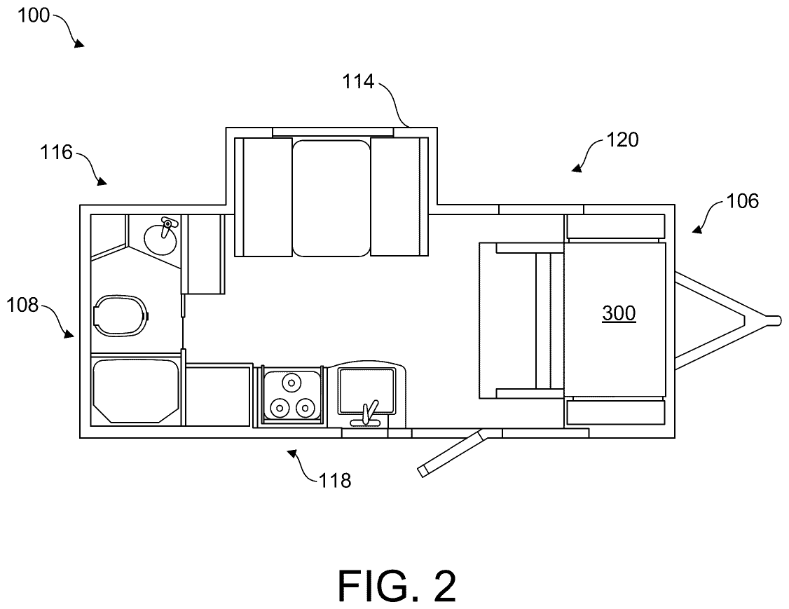

FIG. 2 shows a schematic top view of a living area of the trailer 100. Within the living area is a bathroom area 116, a kitchen area 118, and a bed area 120. The kitchen area 118 can include appliances such as a refrigerator and oven. In the example shown in FIG. 2, the bed area 120 is positioned adjacent the front end of the trailer 100 and includes a bed and cabinet assembly 300, which is described in more detail below. Other arrangements of the internal living area can be used with the features described herein.

### Front Cap

Features of the front cap of the trailer 100 described herein can provide weight savings, increased living space, and/or aerodynamic benefits.

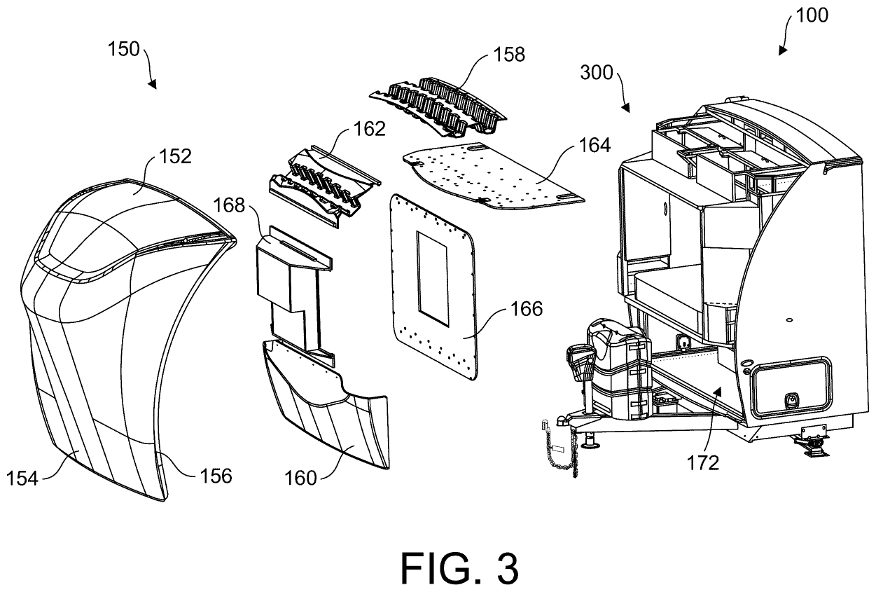

FIG. 3 shows an exploded view of a portion of the trailer 100, including a front cap 150. The front cap 150 includes a front cap structure 152, which includes an exterior surface 154 and an interior surface 156. In certain embodiments, the front cap structure 152 comprises a thermoformable material such that the shape of the front cap structure 152 can be created by heating the thermoformable material while in a mold. Example thermoformable materials include acrylonitrile butadiene styrene (ABS), thermoplastic polyolefin (PTO), and the like. One or more of these materials can be used in other components of the front cap 150 described herein, including the various stiffener members. The front cap structure 152 can be a multi-layer structure with one or more layers of ABS and an acrylic material. As will be described in more detail below, the exterior surface 154 of the front cap structure 152 can be shaped to provide aerodynamic benefits.

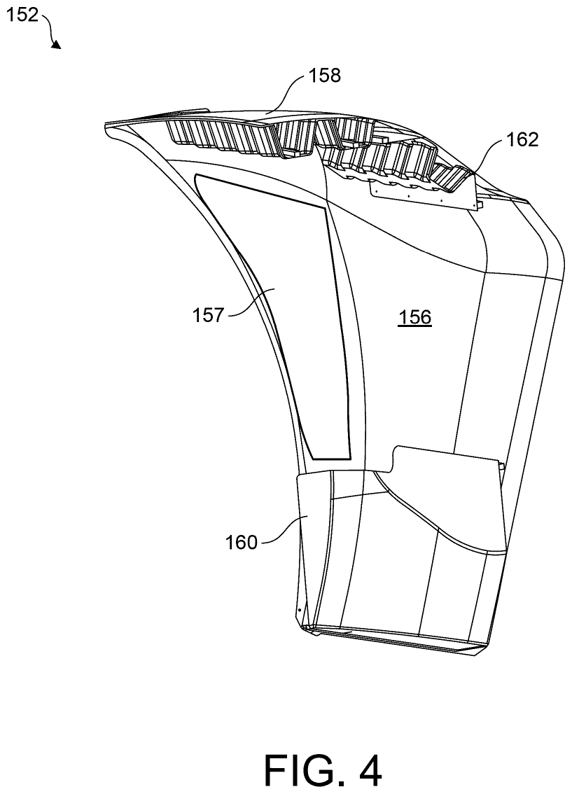

FIG. 3 shows various components of the front cap 150 in an unassembled state, whereas FIG. 4 shows several components of the front cap 150 in an assembled state. FIG. 4 is a partial cross section view and shows the interior surface 156 of the front cap structure 152 and additional components of the front cap 150. The interior surface 156 forms a concave shape such that various components can be positioned within a cavity created by the interior surface 156. The concave shape also creates additional volume for the interior living area of the trailer 100 compared to trailers with traditional front cap designs.

In FIG. 4, a first stiffener member 158 is coupled to the interior surface 156 of the front cap structure 152. In certain embodiments, the first stiffener member 158 comprises a thermoformable material and is coupled to the interior surface 156 via thermoforming such that the first stiffener member 158 is integral formed with the front cap structure 152. The first stiffener member 158 can be designed to provide structural support to the front cap structure 152 when the front cap 150 is installed to the trailer 100. For example, the first stiffener member 158 can provide structural support against forces such as wind when the trailer is being pulled, structural support if snow has accumulated on the front cap structure 152, and/or structural support if a person is standing or sitting on the front cap structure 152.

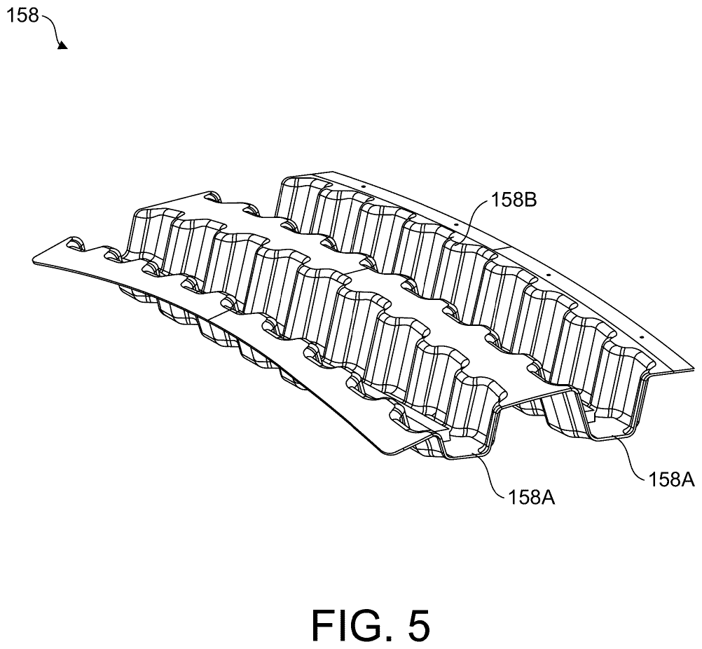

Additional features of the first stiffener member 158 can be seen in FIG. 5, which is a top perspective view. In certain embodiments, the first stiffener member 158 includes one or more protrusions 158A that extend from the interior surface 156 towards a component of the trailer 100. In some embodiments, the first stiffener member 156 is a hat stiffener, which includes ribs 158B along the protrusions 158A.

Referring back to FIG. 4, a second stiffener member 160 is shown being coupled to the interior surface 156 of the front cap structure 152. In certain embodiments, the second stiffener member 160 comprises a thermoformable material and is coupled to the interior surface 156 via thermoforming such that the second stiffener member 160 is integral formed with the front cap structure 152. The second stiffener member 160 can be designed to provide structural support to the front cap structure 152 when the front cap 150 is installed to the trailer 100. For example, the second stiffener member 160 can provide structural support against forces such as wind when the trailer is being pulled. The second stiffener member 160 can be positioned on a bottom half or bottom quarter of the front cap structure 152 to provide support for the bottom portion of the front cap 150.

A third stiffener member 162 is shown in FIG. 4 as being coupled to the interior surface 156 of the front cap structure 152. In certain embodiments, the third stiffener member 162 comprises a thermoformable material and is coupled to the interior surface 156 via thermoforming such that the third stiffener member 162 is integral formed with the front cap structure 152. The third stiffener member 162 can be designed to provide structural support to the front cap structure 152 when the front cap 150 is installed to the trailer 100. For example, the third stiffener member 162 can provide structural support against forces such as wind when the trailer is being pulled or can provide structure support if snow has accumulated on the front cap structure 152. Similar to the first stiffener member 158, the third stiffener member 162 can include one or more protrusions, ribs, hat stiffener shapes, etc., that extend from the interior surface 156 and that provide rigidity.

In certain embodiments, the front cap structure 152 and each of the stiffener members shown in FIG. 4 are integrally formed with each other (e.g., via thermoforming) to create a single unit. As such, the front cap structure 152 along with the stiffener members can be installed to the trailer 100 in one piece. In certain embodiments, the front cap 150 does not include a metal frame (e.g., an aluminum frame, a steel frame) or a wood frame. Without such frames, the front cap 150 can be made lighter than traditional front cap designs, which require using a frame such as an aluminum frame to provide structural rigidity. Reducing the weight of the front cap 150 (compared to other designs) can reduce the overall weight of the trailer. In certain embodiments, the front cap 150 can also include insulation (e.g., fiberglass-based insulation, foam-based insulation). For example, insulation 157 can be directly coupled to the interior surface 156.

Referring back to FIG. 3, the trailer 100 includes various panels that help with securing the front cap 150 to the trailer 100 and/or that help provide storage in the interior living space. In the example of FIG. 3, the panels include a first panel 164 and a second panel 166. The first panel 164 is used to provide a structure to which the first stiffener member 158 is fastened to. The second panel 166 is used to provide a cutout for a cabinet 168 and an interior facing surface, which ultimately can be surface treated (e.g., painted) to improve the visual appearance within the interior living space. In certain embodiments, the panels comprise a polymer and/or metal that provide additional structural rigidity to the trailer 100. The panels can have a honeycomb-shaped core (e.g., made from polypropylene or aluminum) to save weight, and the core can be sandwiched between thin layers that provide a generally flat surface on the top and bottom sides of the core.

In certain embodiments, an insulation material 157 (FIG. 4) is positioned between the various panels and the front cap 150 (e.g., the various stiffener members).

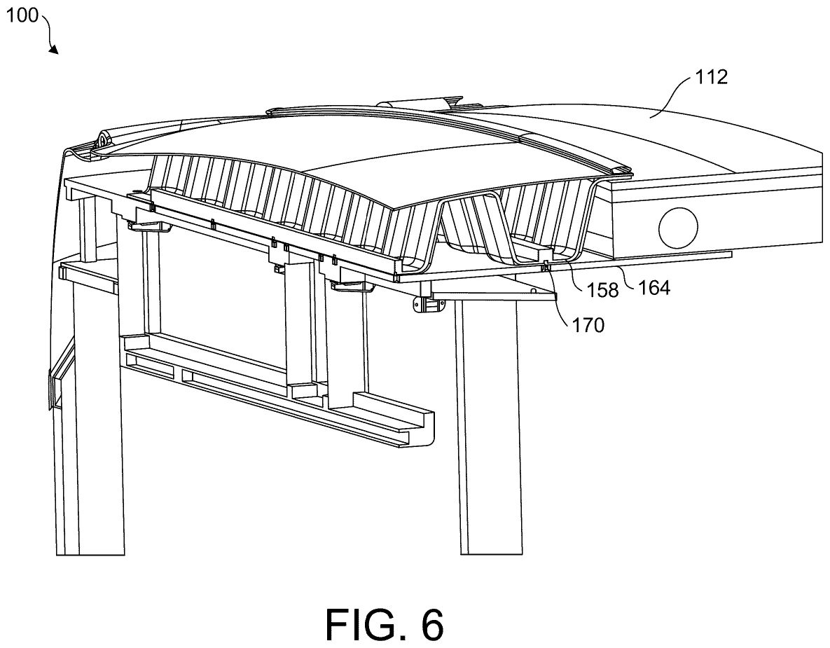

Now referring to FIG. 6, the first panel 164 is shown installed in the trailer 100. The first panel 164 provides a surface to which the first stiffener member 158 contacts and is fastened to, which assists with coupling the front cap 150 to the rest of the trailer 100. As shown in FIG. 6, fasteners 170 such as screws (e.g., self-tapping screws) can pass through the first panel 164 and through the first stiffening member 158 into cross members (e.g., such as a wood-based board) to help couple the front cap 150 to the rest of the trailer 100. The first panel 164 can be coupled to a frame (e.g., a wood-based frame) of the trailer 100 via fasteners such as screws.

The front cap structure 152 can include holes for fasteners to pass through. The fasteners can couple the front cap structure 152 (and ultimately the front cap 150) to the rest of the trailer 100. For example, the fasteners can pass through the holes and into portions of the roof 112 of the trailer 100. The exposed parts of the fasteners can then be covered by an adhesive to reduce drag due to the fasteners and the holes.

Referring back to FIG. 3, the trailer 100 includes the bed and cabinet assembly 300, and one or more of the panels can be coupled to parts of the bed and cabinet assembly 300 via fasteners. A heating, ventilation, and air-conditioning (HVAC) unit 172 can be positioned under the bed portion of the bed and cabinet assembly 300. Typically, an HVAC unit is positioned on a roof of a trailer. Positioning the HVAC unit 172 within the living space instead of on the roof removes the effect of drag that a roof-based HVAC unit would have created. Further, positioning the HVAC unit 172 within the living space allows the HVAC unit 172 to work more efficiently than a roof-based HVAC unit (e.g., because a roof-based HVAC unit is exposed to the sun, which impacts efficiency). Further yet, positioning the HVAC unit 172 within the living space eliminates certain water leak paths.

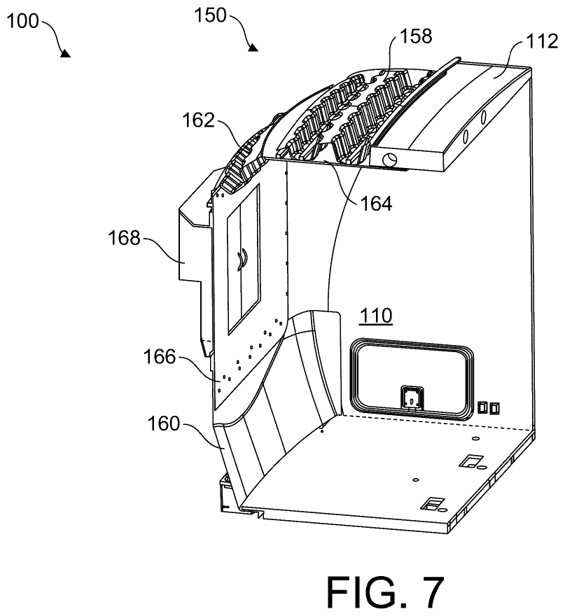

FIG. 7 shows certain parts of the front cap 150 and the trailer 100 when the front cap 150, the first panel 164, the second panel 166, and the cabinet 168 are installed on the trailer 100. As shown, the first stiffener member 158 is positioned between the roof 112 and the third stiffener member 162, and the third stiffener member 162 is fastened to the second panel 166 as well as the first panel 164. The second stiffener member 160 is fastened to the second panel 166, a floor of the trailer 100, and the sidewalls 110 of the trailer 100.

The cabinet 168 is fastened to the second panel 166 such that the cabinet 168 lines up with the cutout in the second panel 166. The cabinet 168 can create storage space within the cavity created by the shape of the front cap 150. As such, in certain embodiments, the stiffening members not only assist with structural support of the front cap structure, but the stiffening members also provide a structure to which the second panel 166 can be attached to create additional storage space in the living area.

### Bed and Cabinet Assembly

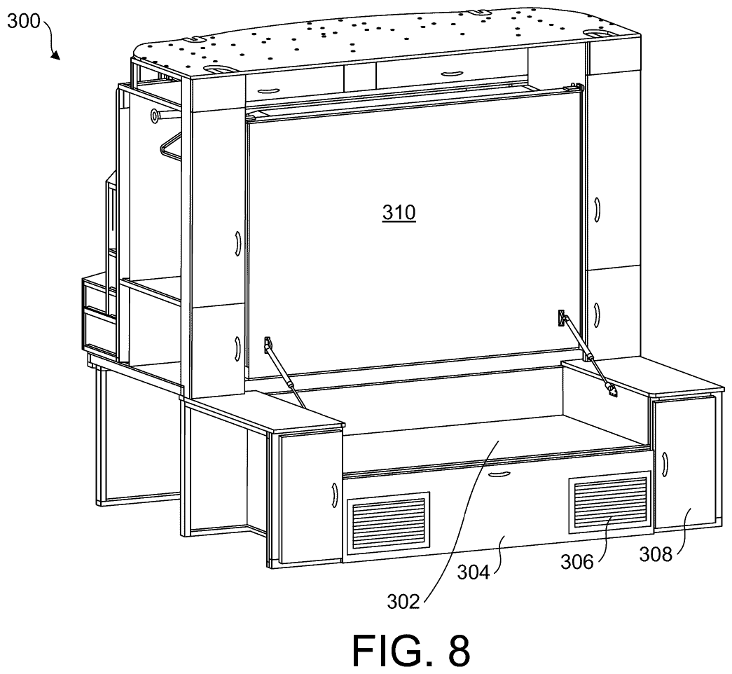

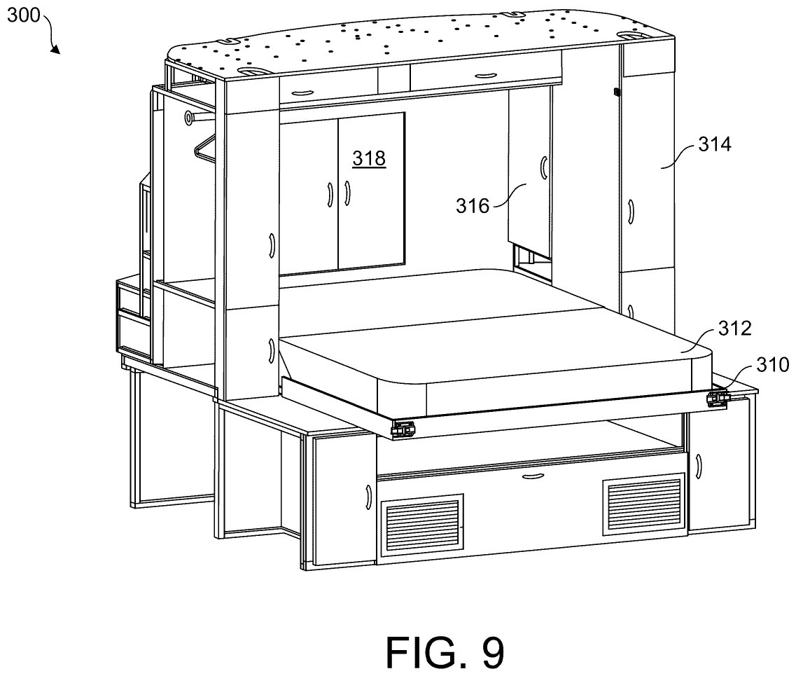

FIGS. 8 and 9 show views of the bed and cabinet assembly 300 (hereinafter “the assembly 300” for brevity). FIG. 8 shows the assembly 300 in a sofa configuration, and FIG. 9 shows the assembly 300 in a bed configuration.

In FIG. 8, the assembly 300 is shown with a seating surface 302 on which one or more cushions or another type of padding can be set. An access door 304 can be positioned directly underneath the seating surface 302 and configured to open (e.g., rotate downward) to provide access to the HVAC unit 172 (shown in FIG. 3 and described above). The access door 302 can have one or more vents 306, which can functions as return air vents for the HVAC 172. Lower storage cabinets 308 can be positioned on opposing sides of the seating surface 302. The top surfaces of the lower storage cabinets 308 can function as arm rests.

The assembly 300 includes a rotatable platform 310 that can function as a backrest in the sofa configuration and a support platform in the bed configuration. The platform 310 can rotate approximately 90 degrees from the sofa configuration to the bed configuration.

As shown in FIG. 9, the platform 310 extends horizontally such that a mattress 312 can be used to sleep on. In certain embodiments, the mattress 312 is foldable. For example, one portion of the mattress 312 can rotate along with the platform 310 while another portion of the mattress 312 does not rotate (e.g., remains extending along a horizontal plane parallel to the seating surface 302).

In certain embodiments, the platform 310 is supported by the lower storage cabinets 308. For example, a bottom surface of the platform 310 can contact the top surfaces of the lower storage cabinets 308 such that the platform 310 rests on the lower storage cabinets 308 when in the bed configuration.

For additional storage space, the assembly 300 can include one or more additional sets of upper storage cabinets 314 on opposing sides of the platform 310 and above the platform 310. The assembly 300 can further include rear cabinets 316 on opposing sides of the platform 310 that can be accessed when the platform 310 is in the bed configuration but not when the platform 310 is in the sofa configuration. The assembly 300 includes doors 318 to access the cabinet 168 (shown in FIGS. 3 and 7). Each cabinet shown in FIGS. 8 and 9 can have its own door or set of doors that can be locked, and each cabinet can include one or more shelves.

### Front Cap Aerodynamics

As noted above, the external surface of the front cap can be shaped to provide aerodynamic benefits (e.g., reducing drag) compared to traditional front cap designs. Because the external surface is an air-bearing surface when the trailer is being pulled, reducing aerodynamic drag of the trailer 100 improves fuel economy and/or battery energy use (and therefore driving range) of the towing vehicle and/or the trailer 100 itself if self-propelled. Further, the external surface of the front cap can utilize smooth transitions (e.g., by reducing or eliminating sharp corners) between the front cap and the roof and/or walls of the trailer 100. This aids in keeping aerodynamic flow attached to the roof and/or walls at the front-cap-to-roof and/or front-cap-to-walls transitions-which reduces the amount of separated aerodynamic flow at such transitions.

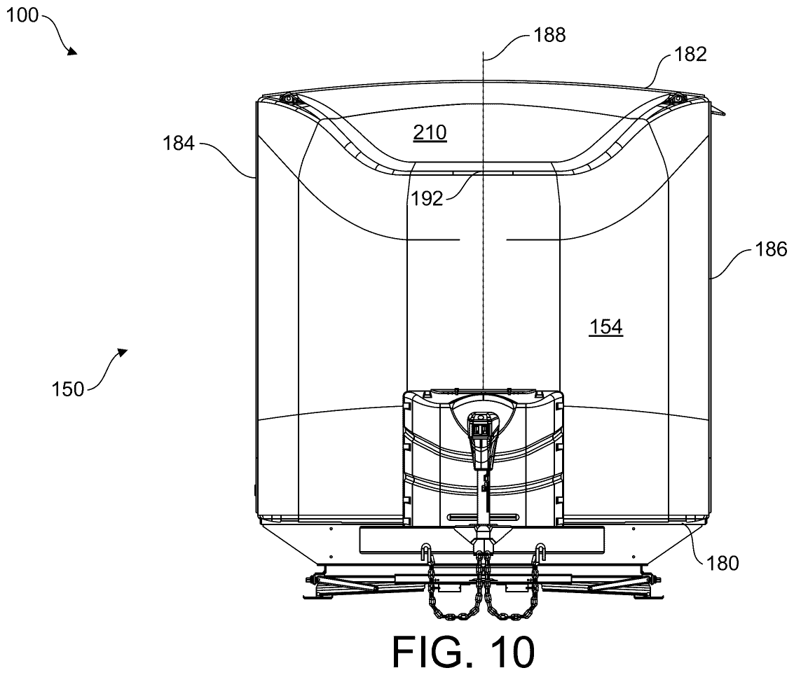

FIG. 10 shows a front view of the front cap 150, particularly the exterior surface 154 of the front cap structure 152. The exterior surface 154 includes a bottom end 180, a top end 182, a first side 184, and a second side 186. The exterior surface 154 forms a convex surface between the bottom end 180 and the top end 182 as well as between the first side 184 and the second side 186. The dotted line denoted by reference number 188 represents the middle of the front cap 150.

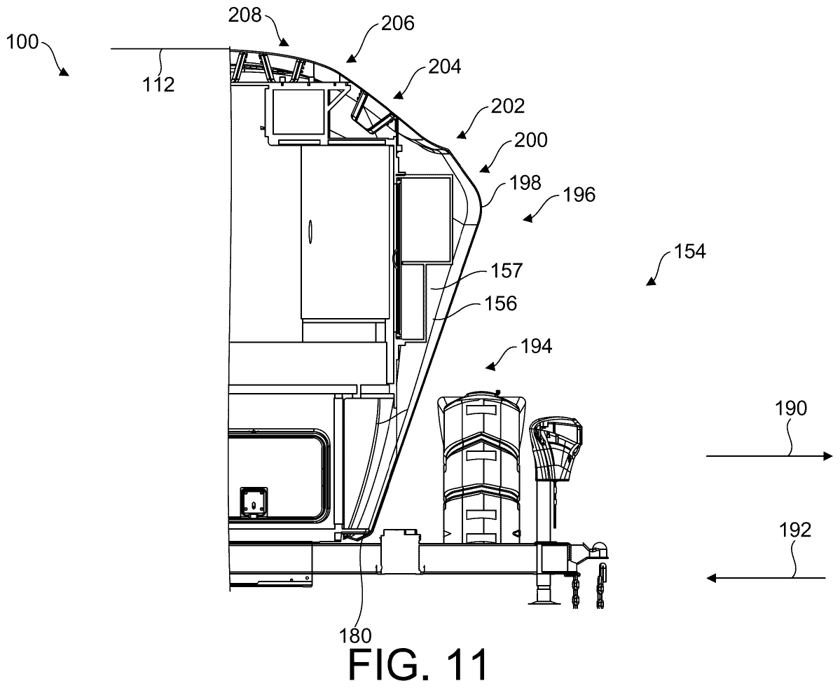

In short, the shape of the exterior surface 154 of the front cap 150 includes tapered sides and a tapered top, coupled with a two-stage top transition that reduce aerodynamic drag. The shape is described in more detail with reference to FIG. 11.

FIG. 11 shows a side cutaway view of certain parts of the front cap 150 and a portion of the trailer 100. The profile of the exterior surface 154 shown in FIG. 10 is described in detail below and is along the middle 188 (shown in FIG. 10) of the front cap 150. The profile is described starting with the section nearest to the bottom end 180 and with reference to a positive direction (denoted by arrow 190), a negative direction (denoted by arrow 192), and slope angles relative to respective horizontal axes such that all slope angles are between 0 and 90 degrees.

The exterior surface 154 includes a lower section 194 along which the exterior surface 154 extends in the positive direction. In certain embodiments, the exterior surface 154 has at least one substantially linear portion along the lower section 194. In the example of FIG. 11, a majority of the exterior surface 154 along the lower section 194 is linear. The slope of the exterior surface 154 along the lower section 194 can range from 60-80 degrees (relative to a horizontal axis) and more particularly 65-75 degrees and even more particularly 68-72 degrees.

The exterior surface 154 next includes a first transition section 196, which includes a rounded nose or distal end 198 of the front cap 150. The first transition section 196 crests at the distal end 198 such that the external surface 154 transitions from extending in the positive direction 190 to the negative direction 192.

The exterior surface 154 next includes a first middle section 200 along which the exterior surface 154 extends in the negative direction 192. In certain embodiments, the exterior surface 154 has at least one substantially linear portion along the first middle section 200. In the example of FIG. 11, a majority of the exterior surface 154 along the first middle section 200 is linear. The slope of the exterior surface 154 along the first middle section 200 can range from 45-65 degrees (relative to a horizontal axis) and more particularly 50-60 degrees and even more particularly 53-57 degrees.

The exterior surface 154 next includes a second transition section 202, which includes a rounded nose or section. The second transition section 202 can be considered to have a non-linear profile or a profile that includes one or more curves that transition from the slope of the first middle section 200 to the slope of a second middle section (or a top section in certain embodiments).

The exterior surface 154 next includes a second middle section 204 along which the exterior surface 154 extends in the negative direction 192. In certain embodiments, the exterior surface 154 has at least one substantially linear portion along the second middle section 204. In the example of FIG. 11, a majority of the exterior surface 154 along the second middle section 204 is linear. The slope of the exterior surface 154 along the second middle section 204 can range from 15-35 degrees (relative to a horizontal axis) and more particularly 20-30 degrees and even more particularly 23-27 degrees.

Next, the exterior surface 154 includes a top section 206 along which the exterior surface 154 extends in the negative direction 192. In certain embodiments, the exterior surface 154 has at least one substantially linear portion along the top section 206. In the example of FIG. 11, a majority of the exterior surface 154 along the top section 206 is linear. The slope of the exterior surface 154 along the top section 206 can range from 30-50 degrees (relative to a horizontal axis) and more particularly 35-45 degrees and even more particularly 38-42 degrees.

The exterior surface 154 next includes a third transition section 208, which gradually tapers (e.g., a gradual reduction in slope angle) until the front cap 150 transitions to the roof 112 of the trailer 100.

As noted above, insulation 157 can be positioned between the various panel members and the interior surface 156 along different parts of the front cap 150.

Briefly referring back to FIG. 10, the section above the distal end 198 of the front cap 150 can include an inset surface portion 210. The inset surface portion 210 gradually tapers towards the roof 112 of the trailer 100 (as shown in the side profile in FIG. 11) as well as from the middle 188 of the trailer body towards the respective first side 184 and the second side 186 of the trailer body.

In certain instances, the front cap 150 does not include any sharp corners or edges. Instead, the front cap 150 has curved transitions along sections where the exterior surface 154 of the front cap 150 transitions between different directions (e.g., the positive direction 190 to the negative direction 192 in FIG. 11) or angles. Further, the exterior surface 154 can include curved transitions between the front cap 150 and the sidewalls 110 and the roof 112 of the trailer 100.

### Rear Cap Aerodynamics

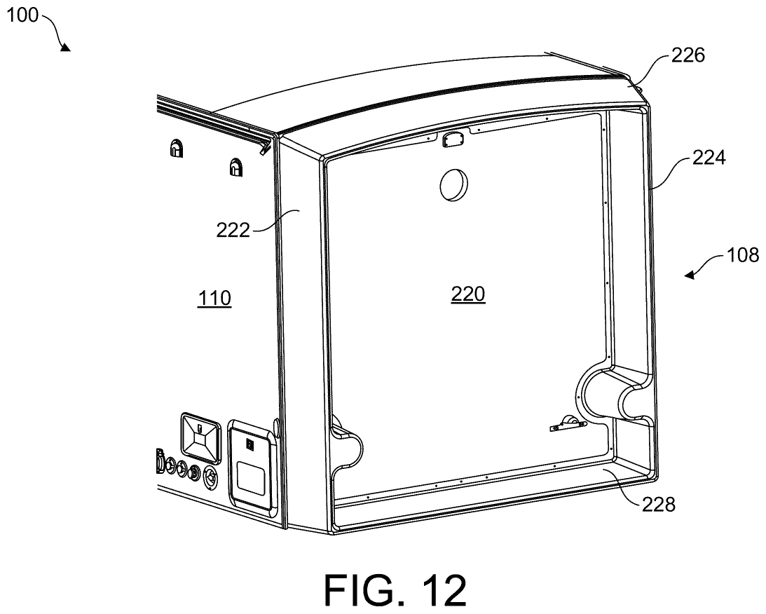

FIG. 12 shows the rear end 108 of the trailer 100. The rear end 108 includes features that provide aerodynamic benefits compared to traditional rear cap designs. The features create a structure that forms a cavity at the rear end 108 of the trailer 100. The cavity reduces aerodynamic drag of the trailer 100 (compared to trailers without such features) via reduction of the strength of the trailing vortices in the wake of the trailer 100. The wake behind trailers is a significant contributor to aerodynamic drag. The cavity created by the structures shown in FIG. 12 helps weaken vortices that are created at the rear end 108 of the trailer 100. The reduction in trailing vortices ultimately results in improved wake closure (e.g., distance from the rear of the trailer 100 at which centerline flow is reestablished).

The rear end 108 of the trailer 100 includes a back wall 220. A cavity is formed by walls that extend away from and past the back wall 220. The walls include a first rear sidewall 222, a second rear sidewall 224, a top wall 226, and a bottom wall 228. In certain instances, the bottom wall 228 is optional (e.g., in designs where a rear bumper would interfere). In certain embodiments, each wall extends the entire vertical length (in the case of the sidewalls) and the entire horizontal length (in the case of the top and bottom walls) of the trailer 100, and each of the walls are connected to at least one other wall such that there are no gaps from wall-to-wall. In other embodiments, none of the walls are connected to each other such that there are gaps between each adjacent wall.

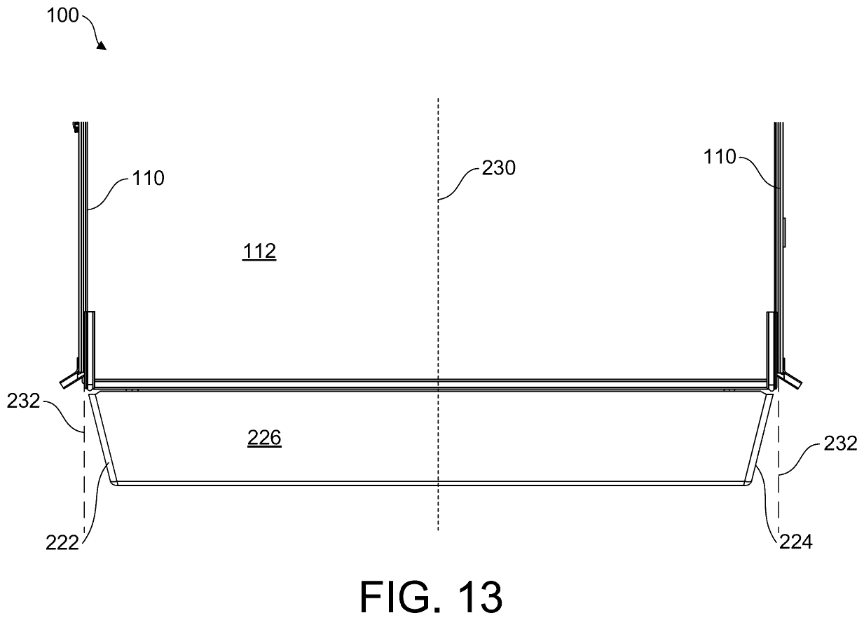

FIG. 13 shows a top view of the trailer 100 and the first rear sidewall 222, the second rear sidewall 224, and the top wall 226. As can be seen, the first rear sidewall 222 and the second rear sidewall 224 are angled towards a middle axis 230 of the trailer 100. The angle of the first rear sidewall 222 and the second rear sidewall 224 can vary. In some embodiments, the angles are 10-25 degrees (e.g., 12-20 degrees, 13-16 degrees) relative to a plane (represented by dotted lines 232) of the sidewalls 110 of the trailer 100. As can be seen, the sides of the top walls 226 can be angled to match the angle of the first rear sidewall 222 and the second rear sidewall 224. The top wall 226 can also be angled such that the top wall 226 is angled downward towards the bottom of the trailer 100. This angle of the top wall 226 can be within the same ranges described above for the sidewalls. In embodiments with the bottom wall 228, the bottom wall 228 may not be angled and instead extend away from the back wall 220 horizontally at a zero-degree angle.

The length of the first rear sidewall 222, the second rear sidewall 224, the top wall 226, and the bottom wall 228 can vary. In certain embodiments, the length (e.g., the distance from the back wall 220 as measured along a horizontal axis) for each of the walls is 100-600 mm (e.g., 150-510 mm, 200-400 mm).

### Methods

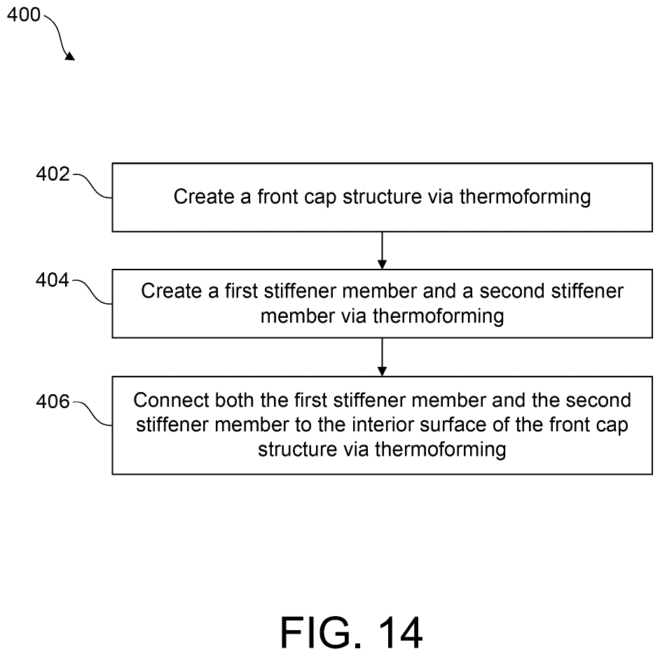

FIG. 14 shows a flowchart of an example method 400 of making a front cap. The method 400 includes creating a front cap structure via thermoforming (block 402 in FIG. 14). The front cap structure includes an exterior surface and an interior surface, and the front cap structure comprises a first thermoformable material. The method 400 further includes creating a first stiffener member and a second stiffener member via thermoforming (block 404 in FIG. 14). The first stiffener member comprises a second thermoformable material, and the second stiffener comprises a third thermoformable material. The method 400 includes connecting both the first stiffener member and the second stiffener member to the interior surface of the front cap structure via thermoforming (block 406 in FIG. 14).

### Fifth Wheel Trailers

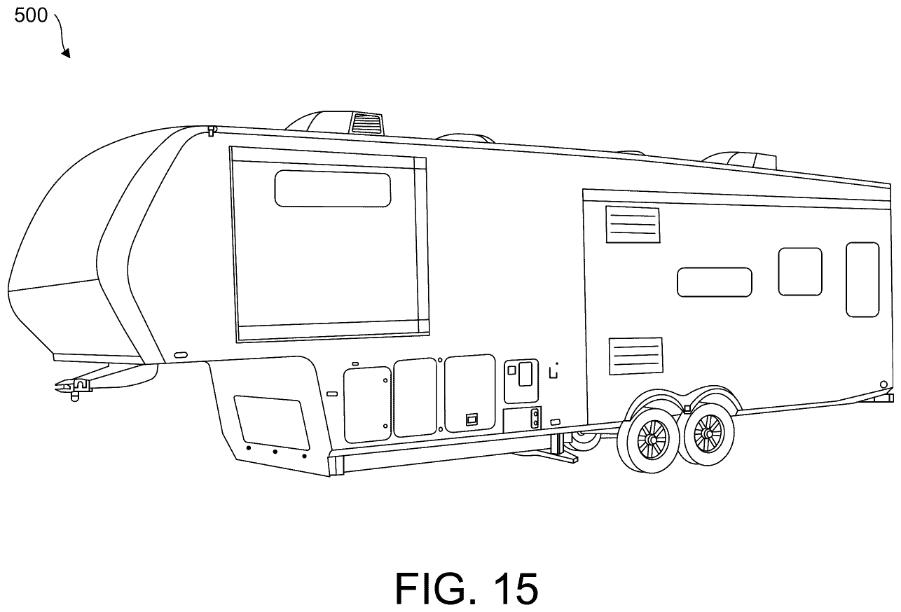

FIG. 15 shows a fifth wheel trailer 500. The front cap aerodynamics and/or the rear cap aerodynamics described herein with respect to the trailer 100 can be used with a fifth wheel trailer such as the trailer 500 in FIG. 16. Although the hitch mechanisms of the trailer 500 are different than the trailer 100, the front cap of the trailer 500 can incorporate design features such as reducing or eliminating sharp edges/corners and using curved transitions as the exterior surface changes between angles and directions. Similarly, the rear end of the trailer 500 can utilize a structure that creates a cavity to reduce aerodynamic drag due to the wake at the back of the trailer 500.

### Exemplary Aspects

Aspect A1. A front cap comprising an exterior surface having a side profile along a central cross-sectional plane, wherein the side profile comprises: a bottom section extending along a first positive slope in a positive direction; a first middle section extending along a second positive slope in a negative direction; a first transition section extending between the bottom section and the first middle section, the first transition section including a distal tip of the front cap; a top section extending along a third positive slope in the negative direction; and a second transition section extending between the first middle section and the top section, the second transition section has a curved profile.
A2. The front cap of A1, wherein the second positive slope is greater relative to a horizontal axis than the third positive slope.
A3. The front cap of A1, wherein the second positive slope is 45-65 degrees relative to a horizontal axis, wherein the third positive slope is 30-50 degrees relative to the horizontal axis.
A4. The front cap of A1, wherein the side profile comprises a second middle section extending along a fourth positive slope in the negative direction between the first middle section and the top section.
A5. The front cap of A4, wherein the second positive slope is greater relative to a horizontal axis than the third positive slope and the fourth positive slope.
A6. The front cap of A5, wherein the third positive slope is greater relative to the horizontal axis than the fourth positive slope.
A7. The front cap of A4, wherein the second positive slope is 45-65 degrees relative to a horizontal axis, wherein the third positive slope is 30-50 degrees relative to the horizontal axis, wherein the fourth positive slope is 15-35 degrees relative to the horizontal axis.
A8. The front cap of A4, wherein the side profile comprises a third transition section extending between the top section and the second middle section.
A9. The front cap of A1, wherein a majority of the bottom section, the first middle section, and the top section is linear.
A10. The front cap of A1, wherein the side profile includes a third transition section that tapers between the top section and a top end of the front cap.
A11. The front cap of A1, wherein the external surface is an air-bearing surface during transit.
A12. The front cap of A1, wherein the front cap does not include an aluminum frame.
A13. The front cap of A1, further comprising a first stiffener member coupled to an interior surface of the front cap; and a second stiffener member coupled to the interior surface.
A14. The front cap of A13, wherein the first stiffener member and the second stiffener member comprise a thermoformable material.
A15. The front cap of A14, wherein the thermoformable material comprises acrylonitrile butadiene styrene.
A16. The front cap of A14, wherein the first stiffener member and the second stiffener member are coupled to the interior surface via thermoforming such that the first stiffener member and the second stiffener member are integral with the front cap.
A17. The front cap of A13, wherein the first stiffener member includes a hat stiffener.
A18. The front cap of A13, wherein the first stiffener member is positioned to support the top section.
A19. The front cap of A13, further including a front cap structure with the external surface and the interior surface.
A20. The front cap of A13, further including a third stiffener member comprising a thermoformable material.
Aspect B1. A towable trailer comprising: an internal frame comprising wood; a chassis supporting the internal frame; and a front cap comprising a front cap structure with an external surface of the towable trailer, the front cap further comprising a first stiffener member and a second stiffener member integrally formed with the front cap structure, wherein the front cap is coupled to the internal frame.
B2. The towable trailer of B1, wherein the first stiffener member and the second stiffener member are integrally formed with the front cap structure via thermoforming.
B3. The towable trailer of B2, wherein the first stiffener member, the second stiffener member, and the front cap structure comprise a thermoformable material.
B4. The towable trailer of B3, wherein the thermoformable material comprises acrylonitrile butadiene styrene.
B5. The towable trailer of B1, wherein the first stiffener member comprises a hat stiffener.
B6. The towable trailer of B1, wherein the front cap does not include an aluminum frame.
B7. The towable trailer of B1, further including a panel positioned between the first stiffener member and the internal frame.
B8. The towable trailer of B7, wherein the panel is fastened to the first stiffener member and is fastened to the internal frame.
B9. The towable trailer of B7, wherein the panel comprises a polymer.
B10. The towable trailer of B9, wherein the panel further comprises a metal.
B11. The towable trailer of B1, wherein the front cap is fastened to a roof of the towable trailer.
B12. The towable trailer of B1, further including a panel and a cabinet, wherein the panel is positioned between the front cap and the internal frame, wherein the cabinet is positioned between the front cap and the panel.
B13. The towable trailer of B1, wherein the internal frame forms at least a part of a bed and cabinet assembly.
B14. The towable trailer of B13, further including a heating, ventilation, and air conditioning (HVAC) unit positioned within the bed and cabinet assembly.
B15. The towable trailer of B14, wherein a roof of the towable trailer does not include an HVAC unit.
B16. The towable trailer of B14, wherein the bed and cabinet assembly includes an access door to provide access to the HVAC unit.
B17. The towable trailer of B16, access door includes a return air vent.
B18. The towable trailer of B13, wherein the bed and cabinet assembly includes a rotatable platform that is rotatable between a backrest position and a bed position.
B19. The towable trailer of B18, wherein the bed and cabinet assembly includes cabinets on opposing sides of the rotatable platform and above the rotatable platform.
B20. The towable trailer of B18, further comprising a foldable mattress.
Aspect C1. A towable trailer comprising: a trailer body including a front cap, a first side wall, a second side wall, a roof, and a rear wall; a first side fairing extends from the rear wall adjacent to the first side wall; a second side fairing extends from the rear wall adjacent to the second side wall; and a top fairing extends from the rear wall adjacent to the roof, wherein the first side fairing, the second side fairing, and the top fairing extend from the rear wall without contacting the first side wall, the second side wall, or the roof.
C2. The towable trailer of C1, further comprising a lower fairing extending from the rear wall below the top fairing.
C3. The towable trailer of C2, wherein the lower fairing extends from the rear wall without contacting the first side wall, the second side wall, or the roof.
C4. The towable trailer of C1, wherein the first side fairing, the second side fairing, and the top fairing create a rear cavity.
C5. The towable trailer of C1, wherein the first side wall extends along a first plane, wherein the first side fairing has a first external surface that extends at a first angle away from the first plane.
C6. The towable trailer of C5, wherein the second side wall extends along a second plane, wherein the second side fairing has a second external surface that extends at a second angle away from the second plane.
C7. The towable trailer of C6, wherein the top fairing has a third external surface that extends at a negative slope at a third angle relative to a horizontal axis.
C8. The towable trailer of C1, wherein the first angle, the second angle, and the third angle are 12-16 degrees.
C9. The towable trailer of C8, further comprising a lower fairing extending from the rear wall at a fourth angle of 88-92 degrees relative to an external surface of the rear wall.
C10. The towable trailer of C8, wherein the first side fairing, the second side fairing, and the top fairing extend no more than 20-30 centimeters behind the rear wall.
C11. The towable trailer of C1, wherein the first side fairing, the second side fairing, and the top fairing extend no more than 15-51 centimeters behind the rear wall.
C12. The towable trailer of C1, wherein the first side fairing, the second side fairing, and the top fairing extend no more than 20-30 centimeters behind the rear wall.
C12. The towable trailer of C1, wherein the front cap includes an exterior surface having a side profile along a central cross-sectional plane, wherein the side profile comprises: a bottom section extending along a first positive slope in a positive direction; a first middle section extending along a second positive slope in a negative direction; a first transition section extending between the bottom section and the first middle section, the first transition section including a distal tip of the front cap; a top section extending along a third positive slope in the negative direction; and a second transition section extending between the first middle section and the top section, the second transition section has a curved profile.
C13. The towable trailer of C12, wherein the second positive slope is 45-65 degrees relative to a horizontal axis, wherein the third positive slope is 30-50 degrees relative to the horizontal axis.
C14. The towable trailer of C12, wherein the side profile comprises a second middle section extending along a fourth positive slope in the negative direction between the first middle section and the top section.
C15. The towable trailer of C14, wherein the second positive slope is greater relative to a horizontal axis than the third positive slope and the fourth positive slope.
C16. The towable trailer of C14, wherein the second positive slope is 45-65 degrees relative to a horizontal axis, wherein the third positive slope is 30-50 degrees relative to the horizontal axis, wherein the fourth positive slope is 15-35 degrees relative to the horizontal axis.
C17. The towable trailer of C1, wherein the front cap comprises: a front cap structure including an exterior surface and an interior surface, the front cap structure comprising a first thermoformable material; a first stiffener member comprising a second thermoformable material and coupled to the interior surface, the first stiffener member including a first protrusion extending away from the interior surface; and a second stiffener member comprising a third thermoformable material and coupled to the interior surface.
C18. The towable trailer of C17, wherein the first thermoformable material, the second thermoformable material, and the third thermoformable material comprise acrylonitrile butadiene styrene.
C19. The towable trailer of C17, wherein the first stiffener member and the second stiffener member are coupled to the interior surface via thermoforming such that the front cap structure, the first stiffener member, and the second stiffener member are integral with each other.
C20. The towable trailer of C17, wherein the front cap does not include an aluminum frame.
Aspect D1. A towable trailer with a combination of A1-A20, B1-B20, and/or C1-C20.
D2. The towable trailer of D1, wherein the towable trailer is a travel trailer.
D3. The towable trailer of D1, wherein the towable trailer is a fifth wheel trailer.

### CONCLUSION

Various modifications and additions can be made to the embodiments disclosed without departing from the scope of this disclosure. For example, while the embodiments described above refer to particular features, the scope of this disclosure also includes embodiments having different combinations of features and embodiments that do not include all of the described features. Accordingly, the scope of the present disclosure is intended to include all such alternatives, modifications, and variations as falling within the scope of the claims, together with all equivalents thereof.

We claim:

1. A front cap for installation onto a towable trailer, the front cap comprising:
a front cap structure including an exterior surface and an interior surface, the front cap structure comprising a first thermoformable material;
a first stiffener member comprising a second thermoformable material and coupled to the interior surface, the first stiffener member including a first protrusion extending away from the interior surface; and
a second stiffener member comprising a third thermoformable material and coupled to the interior surface.

2. The front cap of claim 1, wherein the first thermoformable material, the second thermoformable material, and the third thermoformable material comprise acrylonitrile butadiene styrene.

3. The front cap of claim 1, wherein the first stiffener member and the second stiffener member are coupled to the interior surface via thermoforming such that the front cap structure, the first stiffener member, and the second stiffener member are integral with each other.

4. The front cap of claim 1, further comprising:
a third stiffener member comprising a fourth thermoformable material and coupled to the interior surface.

5. The front cap of claim 1, wherein the second stiffener member comprises a second protrusion extending away from the interior surface.

6. The front cap of claim 1, wherein the first stiffener member includes a hat stiffener.

7. The front cap of claim 1, wherein the exterior surface has a side profile along a central cross-sectional plane, wherein the side profile comprises: a bottom section extending along a first positive slope in a positive direction, a first middle section extending along a second positive slope in a negative direction, a first transition section extending between the bottom section and the first middle section, the first transition section including a distal tip of the front cap.

8. The front cap of claim 7, wherein the side profile further comprises a top section extending along a third positive slope in the negative direction, and a second transition section extending between the first middle section and the top section, the second transition section has a curved profile.

9. The front cap of claim 8, wherein the second positive slope is greater relative to a horizontal axis than the third positive slope.

10. The front cap of claim 8, wherein the second positive slope is 45-65 degrees relative to a horizontal axis, wherein the third positive slope is 30-50 degrees relative to the horizontal axis.

11. The front cap of claim 8, wherein the side profile comprises a second middle section extending along a fourth positive slope in the negative direction between the first middle section and the top section.

12. The front cap of claim 11, wherein the second positive slope is greater relative to a horizontal axis than the third positive slope and the fourth positive slope.

13. The front cap of claim 1, wherein the front cap structure and the second stiffener member include holes for fasteners.

14. The front cap of claim 1, wherein the first stiffener member includes ribs.

15. The front cap of claim 1, wherein the front cap does not include an aluminum frame.

16. A method for making a front cap for a recreational vehicle, the method comprising:
creating a front cap structure via thermoforming, the front cap structure including an exterior surface and an interior surface, the front cap structure comprising a first thermoformable material;
creating a first stiffener member via thermoforming, the first stiffener member comprising a second thermoformable material;
creating a second stiffener member via thermoforming, the second stiffener comprising a third thermoformable material;
connecting the first stiffener member to the interior surface of the front cap structure via thermoforming; and
connecting the second stiffener member to the interior surface of the front cap structure via thermoforming.

17. The method of claim 16, further comprising:
creating a third stiffener member via thermoforming, the third stiffener comprising a fourth thermoformable material; and
connecting the third stiffener member to the interior surface of the front cap structure via thermoforming.

18. The method of claim 17, wherein the first thermoformable material, the second thermoformable material, the third thermoformable material, and the fourth thermoformable material comprise acrylonitrile butadiene styrene.

19. The method of claim 16, wherein the first stiffener comprises ribs.

20. The method of claim 16, wherein the front cap does not include an aluminum frame.
